(19) United States
(12) Patent Application Publication
(10) Pub. No.: US 2018/0110012 A1
(43) Pub. Date: Apr. 19, 2018

(54) Printed Tracking Device and System and Method for Use in a Low Power Network

(71) Applicant: NanoThings Inc. c/o Corporation Service Company, Albany, NY (US)

(72) Inventors: Timothy WIlliams, New York, NY (US); Gary Lomp, Centerport, NY (US); Friedrich Eibensteiner, Linz (AT); Josep Miquel Jornet, Clarence Center, NY (US)

(73) Assignee: Nanothings Inc., Albany, NY (US)

(21) Appl. No.: 15/703,311

(22) Filed: Sep. 13, 2017

Related U.S. Application Data
(63) Continuation of application No. 62/408,551, filed on Oct. 14, 2016.

(51) Int. Cl. H04W 52/04; B65D 27/30; G06K 19/077

(52) U.S. Cl. CPC H04W 52/04; B65D 27/30; G07B 2017/00629; B65D 2203/10; G06K 19/07749

(57) ABSTRACT

The present invention is a tracking device for use in an LPWAN network, a system for using the tracking device, and a method of using the tracking device. The invention has the advantages of having a small form factor, low power consumption requirements, and long data transmission capabilities. In an embodiment, we describe a tracking device wherein the majority of the electronics are printed on a single substrate. In one variant of this embodiment, only a sensor could be located off-substrate. Embodiments disclosed herein provide a low-cost, versatile tracking device that can provide accurate analytics about a movable article to individuals or machines seeking information related to at least one of a panoply of metrics that could be reported about the moveable article.

### FIELD

The present invention relates generally to a low-cost, versatile, printed tracking device and systems and methods for using the printed tracking device in a low power wide area network (“LPWAN”).

### BACKGROUND

Asset management throughout the world is a multi-billion dollar industry rife with inefficiencies. We define asset management as the tracking of an item as it travels from one place to another. The asset could be a package, a product, a container, a pallet, timber, a piano, a case of wine, blood or other health-related materials, a letter, a magazine, a vehicle, a pet, a human, an electronic device, frozen food, perishable items, and so forth. In short, an asset is anything to which a tracking device could be attached. Accordingly, the asset tracking industry has an unlimited number of use cases.

In the past, asset tracking has varied widely from industry to industry. Generally speaking, the more valuable the asset, the more sophisticated the tracking mechanism has been. On the low-cost asset management end of the spectrum, individuals seeking to track mass mailed media for marketing purposes, for example flyers and brochures, have used very primitive metrics to determine conversion rates of the advertisements sent via traditional mailings.

In the United States the media mail-based marketing and advertising business is a (USD) 46 billion dollar industry. The size of the global industry is at least 10 times that figure. For over a century this industry has operated in a manner that provides only the most primitive feedback relating to the effectiveness of a given mass mailing campaign, namely, whether or not the person converted, the definition of which varies from advertiser to advertiser, and only in such events, will mailing campaign operator will receive positive notification of said recipient's interest in, and response to, the material. However, in the vast majority of cases, the media or parcel is discarded unopened, opened and then discarded, destroyed by the recipient (e.g., shredded) or allowed to remain in any one of a number of states of oblivion.

For more valuable assets, such as cargo that may be transported via truck, train, ship, or airplane, it is well known in the art to use tracking mechanisms such as GPS to track a shipment, whether it is on a truck, train, ship or plane. For these use cases, GPS provides an excellent means of tracking location. It suffers however from some drawbacks. First, most GPS location data are transmitted via cellular networks, which are expensive and power hungry platforms upon which to operate. Although GPS data can be sent via Wi-Fi networks, the short range of these networks is a limiting factor. In addition, GPS tracking does not provide additional information such as temperature, pressure, light exposure, humidity, and so forth for each individual item within a shipment.

Irrespective of the asset to be tracked, design considerations for any asset tracking device include: (1) the cost of hardware production; (2) power consumption; (3) form factor limitations; (4) disposability; and (5) network connectivity cost. In terms of network choices, cellular networks are ubiquitous and have the advantage of providing long range coverage. The downside, however, of cellular networks is the high cost of network access and the power consumption of devices deployed on the cellular network. Wi-Fi and Bluetooth networks are less expensive to deploy, but have limited range. RFID networks, e.g., those in the 125 KHz, 135 KHz, or 13.56 MHz range, have the advantage of providing free access, but also suffer from the very limited tracking range they provide.

There is this a need for a low-cost, versatile tracking device that can provide accurate analytics, including without limitation, location, environmental, and behavioral data, about a movable article or its recipients to individuals or machines seeking information related to at least one of a panoply of metrics that could be reported about the moveable article.

### SUMMARY OF THE INVENTION

The present invention is a tracking device for use in an LPWAN network, a system for using the tracking device, and a method of using the tracking device. The invention has the advantages of having a small form factor, low power consumption requirements, and long range transmission capabilities. In an embodiment, we describe a tracking device wherein the majority of the electronics are printed on a single substrate. A substrate could be any suitably sturdy electrically compatible medium, including without limitation, cardboard, Mylar film, plastic, circuit board, or composites of these or similar materials.

In one variant of this embodiment, only a sensor could be located off-substrate. The printing aspect of the invention includes the use of either conductive ink or metal deposition or a hybrid arrangement according to the conductivity required in a given portion of the circuit.

There are several ways to produce the circuitry with components as functional modules. In one embodiment, we use a classical printed circuit board (“PCB”) made of an epoxy with copper layer, having a protection layer on the copper, whereby a portion of the protection layer is removed. In this embodiment, we include etching in the free copper area. We also strip off the rest of the protection layer from the remaining copper traces. We further include stencil printing of solder paste to the copper traces. The components are “pick & place” and are secured to the PCB via a heating process in a reflow oven for soldering.

In an alternate embodiment, the circuitry could be produced by using a rigid epoxy-copper PCB a thin and flexible Polyimide film with a copper layer in place of the PCB.

In an alternate embodiment, the circuit could be printed via a printing process for conductive traces (e.g. silver traces) to a film (e.g. Polyethylene terephthalate, Polyethylene naphthalate, and the like)) using stencil printing of solder paste. In this embodiment, it would be advisable to use low temperature solder paste because these polymer films cannot stand the high solder temperatures of normal soldering. This embodiment could also place components via “pick & place,” followed by heating up for soldering.

In an additional embodiment, the circuit could be printed via a printing process for conductive traces (e.g. silver traces) to a film (e.g. Polyethylene terephthalate, Polyethylene naphthalate, and the like) and stencil printing or normal printing of a glue or binder, which conductively glues the components to the silver traces. In this embodiment, the circuit could be cured at room temperature or heated up for faster curing.

The printing methods for printing the circuits can vary in alternate embodiments. In one embodiment, one could use a screen printing method or process, which has the advantage of providing relatively thick conductive layers with sufficient resolution. In an alternate embodiment, one could use a gravure printing process, which has the advantage of having a lower thickness than screen printing, while still having good resolution.

In an alternate embodiment, the circuit could be printed with a flexographic printing method, which provides thickness similar to gravure and sufficient resolution.

In alternate embodiments, in order to increase thickness, any of the above printing methods could be combined with printing seed layers having electroplating or electro-less platting thereon.

In these methods, diverse curing methods, such as convection heating, infra-red, ultraviolet, ultrasonic, and photonic, could be used. These curing methods are also useful if sintered nanoparticles are used.

Many different materials can be used to print conductive traces, including without limitation: carbon (including graphene), silver, copper, silver plated copper, organic conductive polymers, tin, and inorganic materials like indium tin oxide.

In one embodiment, we disclose a tracking device for use in a low power wide area network (LPWAN) comprising: a circuit on a substrate, the circuit further comprising a processor, a memory, a transmitter, and a power coupler configured to receive power from an external source; a printed antenna on the substrate communicatively coupled to the circuit; and a sensor communicatively coupled to the circuit. For purposes of clarity, we intend the term “LPWAN” to mean a network operating in one or more ISM bands of any given country.

In an alternate embodiment, the transmitter could be replaced by a transceiver or it could be coupled to a receiver.

In an alternate embodiment, the substrate comprises a thin film, a cardboard member, a plastic member, a paper member, a composite wood member, or a circuit board.

In yet an additional embodiment, the circuit and the antenna are coplanar. In some additional embodiments, there could be multiple antennas, either co-planar or not. These embodiments could include antenna switching means and optionally a ground plane. Antennas in any of these embodiments could be single band, dual band, broadband, directional, omni-directional, high gain, low gain, and any combination thereof.

In another embodiment, the processor is a small state machine or a micro-coded bit slice processor.

In a further embodiment, the tracking device further comprises a clock.

In an alternate embodiment, the sensor is configured to monitor at least one data metric the data metric comprising one or more of: a temperature, a measurement of relative humidity, a traveling velocity, an acceleration, a measure of light, a shock, a pressure, a vibration, a location, a gas, a fire, an orientation in space, a g-force, a sound, a stacking height, a weight, state of integrity, for example if a package has been opened.

In an additional embodiment, the processor is configured to create an event code based on input received from the sensor.

In yet another embodiment, the transmitter is configured to transmit an event code. In an alternate embodiment, wherein we further include a receiver, the receiver could be configured to receive an event code.

In a further embodiment, the tracking device further comprises a power source wherein the power source comprises one or more of a battery, a capacitor, a super capacitor, a solar power collector, or a wireless power device capable of harvesting energy form an ambient field.

In an additional embodiment, the power source is a printed battery, a printed capacitor, a super capacitor, or any combination thereof.

In yet another embodiment, the LPWAN network is a SIGFOX network, a long range radio “LoRa” network, a Weightless network, a Greenwaves network, an LTE-MTC network, a Haystack network, an Ingenu Random Phase Multiple Access, or a Narrow-Band Internet of Things (“N-B IoT”) network.

In a further embodiment, there is a tracking device for use in a low power wide area network (LPWAN) comprising: a circuit on a substrate, the circuit further comprising a finite state machine, a transmitter, and a power coupler configured to receive power from an external source; a printed antenna on the substrate communicatively coupled to the circuit; and a sensor communicatively coupled to the circuit.

We additionally disclose a tracking system for tracking at least one data metric of an item comprising a tracking device for use in a low power wide area network (LPWAN) comprising: a circuit on a substrate, the circuit further comprising a processor, a memory, a transmitter, and a power coupler configured to receive power from an external source; a printed antenna on the substrate communicatively coupled to the circuit; and a sensor communicatively coupled to the circuit; a low power wide area network configured to receive and transmit the data metric; and a computer processor configured to receive and analyze the data metric. In this and other embodiments herein the substrate can be printed or etched on polymer film.

We further disclose a method of tracking an item using a tracking device for use in a low power wide area network (LPWAN) comprising: a circuit on a substrate, the circuit further comprising a processor, a memory, a transmitter, and a power coupler configured to receive power from an external source; a printed antenna on the substrate communicatively coupled to the circuit; and a sensor communicatively coupled to the circuit comprising the steps of: receiving from the tracking device a data metric measured by the sensor; and analyzing the data metric in order to determine a tracking state.

### BRIEF DESCRIPTION OF THE DRAWINGS

FIG. 1 is a block diagram of a tracking device according to the present invention.

FIG. 2 is a diagram of a tracking system according to the present invention.

### DETAILED DESCRIPTION

The present invention provides a novel, low cost, real time, information feedback device, system and method that can be used in myriad asset tracking scenarios. Some exemplary use cases are provided with the caveat that these embodiments are intended to be a subset of the wide array of use cases in which the inventive device, system and methods could be used.

Mass Mailing Marketing Use Case. Embodiments disclosed herein can be used to automatically report a mail recipient's actions and reactions to a marketing campaign operator. In particular, the present invention describes and teaches a business method for determining, at a minimum, if a marketing parcel has been opened, and if the contents have been read. This behavioral information is valuable because it can be used to measure the effectiveness of mass mailing as a marketing tool. It will be clear to those familiar with marketing analytics that there are additional types of information that may be provided in the feedback message, including time stamps of events, for example, without limitation, delivery, opening, etc.

The present invention also provides a means for implementing methods using a device capable of accessing public or private wireless networks and of transmitting feedback information from the recipient's location to the campaign operator's endpoint data processing location. In some embodiments, we disclose a device coupled to sensors, which could be embedded within a parcel or other mailed item. In these embodiments, valuable data regarding consumer behavior can be aggregated and stored in cloud computing devices, on servers, and the like. In this use case, users can access new data-analytics methodologies, which have the capability of streamlining marketing and advertising campaigns and expenses while preserving natural resources by eliminating waste. In this way, users can retarget and continuously optimize the parameters of advertising campaigns based on valuable behavioral feedback including package open rates, demographic, geographic and physical data about the parcel's fate.

In addition to mailings as described above, the use of device embodiments in a magazine or similar encapsulation provides an effective and highly efficient method for “closing the loop” on advertising content delivery through advertisements in magazines. By incorporating sensors within an advertisement, or multi-sensors within a plurality of advertisements, advertisers may obtain crucial consumer feedback. The types of feedback and the activation of the feedback by various stimuli, e.g., scratch off, peel off, pressure sensor or other tactile input mechanism, is limited only by the imagination.

In this type of application, the need for microminiaturization is lessened due to the form factor and weight of the carrying media, e.g., magazines. The embodiments described herein may be readily partitioning into a small number of sub-modules so that the configuration of the technology may be optimized to the application and the most efficient deployment may be realized.

In an alternate use case, embodiments herein could be utilized as so-called “belly bands.” One version of a belly band could be a thin strip of paper wrapped around the exterior of a magazine. In this configuration, device embodiments could be added to pre-produced media such as magazine as well as to other packaging that can accept a wrapper. The sensors within the device can detect various actions, which we refer to as a “state of integrity,” such as removal or opening of the exterior wrapper

Parcel Tracking Use Case. Parcel tracking can be implemented directly by including tracking device embodiments in the packaging of the parcel. Parcel tracking can be used to monitor the progress of the parcel through delivery channels. In addition, by configuring the tracking tag with appropriate sensors, the conditions to which the parcel are subjected during transit may be monitored and reported. Exemplary conditions, without limitation, include, travel velocity, location, temperature, humidity, air pressure, g-force, vibration, sound, light, smoke, fire, harmful gas, loss of air pressure, loss of oxygen, and the like.

Primary Asset Tracking. Primary assets may be tracked in a manner similar to the tracking of parcels using embodiments disclosed herein. Certain secondary assets are used in the warehousing and shipping of primary assets. An example of a secondary asset is a pallet. Pallets are used in transport and warehousing operations in which primary assets are loaded on pallets for movement or storage. Pallets are intended to be reusable. A problem that arises in the flow of pallets through a logistics process or channel is, they are often lost or discarded when the primary assets are unloaded. Embodiments disclosed herein can overcome this problem by being integrated within a pallet. In alternate embodiments, the device could be coupled to larger battery sources, renewable power sources, energy harvesting sources and the like to increase the transmit/receive power of device embodiments.

In this use case, it may be desirable to monitor a variety of environmental conditions including, but not limited to, temperature, humidity, exposure to liquid or fire or smoke, velocity of travel, orientation of the item, e.g. “This End Up,” stacking height of items, weight, location, and the like. The type of item metrics would likely vary depending upon the nature of the item. For example, the owner of a piece of fine art who employs embodiments disclosed herein may want to monitor exposure to any environmental elements, humidity, temperature, location, stacking height, orientation, and location. In contrast, an individual shipping a book may just wish to monitor location. The data available in this use case is limited only by the types of sensors available to measure environmental conditions. Different embodiments can be tailored to accommodate a user's desired metrics.

Medical Field Use Case. In the medical field, embodiments can be used to track ambient conditions of medical materials such as tissue, organs, blood, urine, biopsies, cryogenically frozen materials, humans, cadavers, and the like. In this use case, the vitality of such items depends critically on the timeliness of delivery as well as the preservation of controlled environment. Use of the present invention provides a method for monitoring and guaranteeing these variables.

Autonomous Inventory Tracking Use Case. In this alternate case, the disclosed devices can be used to autonomously track inventory and to automatically order additional supplies when inventory begins to run low.

Compliance Tracking Use Case. In an alternate use case, the disclosed devices, systems and methods could be used to ensure compliance with recall protocols such as may be instituted by the Food and Drug Administration and similar administrative bodies. The disclosed embodiments would provide verifiable compliance checking, which would enhance and streamline recall compliance. The disclosed devices can be embedded into recall letters. When the letter is opened, an event code can be transmitted back to a main server or other computing device. The event code would provide verification of receipt of the recall notice, which would be helpful compliance data for the recalling company or entity to obtain. Specifically, the event code can act as verification of receipt of the recall notice.

The present invention allows users to embed device embodiments in media parcels, or other packages, containers or transportable items as described above, which can automatically sense opening of a parcel, opening of the enclosed material and other recipient actions, as well as a multitude of environmental variables. The sensed actions or environmental variables are encoded into a digital feedback message (“event message”) optionally including timestamps. In some embodiments, the digital feedback messages are correlated to identifying information stored in a database paired so as to pairing of the reported action with an entity's physical address or identity.

In embodiments, these digital feedback messages can be optimally tailored to include the minimum necessary information to accomplish the user's tracking goals. In this way, a user can lower bandwidth costs, thereby reducing power transmission requirements and redundancy protocols. In embodiments, it may be desirable to create a communication pathway between a tracked item, irrespective of its use case, and a logistics management client that can track item metrics for either real-time analysis or for historic predictive data purposes.

Some advantages of embodiments disclosed herein include automation in that the system is entirely automatic and requires no manual scanning by third party carriers. The system takes advantage of the emergent Internet of Things (IoT) paradigm. By exploiting IoT platforms, especially certain wireless transport networks that are currently in development and deployment worldwide, e.g., SigFox and Long Range Radio “LoRa” network, the benefits of the present invention may be realized without the need for creating, developing and deploying extensive infrastructure. The present invention works in conjunction with infrastructure that is already available. This infrastructure differs from the cellular infrastructure in that it is optimized for low power, low data rate operation. Cellular and related infrastructure is comparatively expensive to deploy and operate and is not efficient for relaying large volumes of small disjointed data packets from widely distributed sources, such as those used in digital feedback messages of the present embodiments. The biggest differences between cellular and LPWAN networks is, cellular networks operate over licensed frequency bands, which are expensive to purchase/license. LPWAN frequency bands, in contrast, are unlicensed, and therefore free for anyone to use.

Indeed, in some use cases for embodiments disclosed herein, a transmitter within the device may be required to send very short transmissions, e.g., lasting a few tenths of a second. In the mass mailing use case, the transmitter may only need to send a single transmission in order to report the actions taken by the recipient of the mass mailing. This model is in contrast to infrastructure and devices designed to carry large volumes of data from recurring usage instances, e.g., cell phone calls, video streaming, etc.

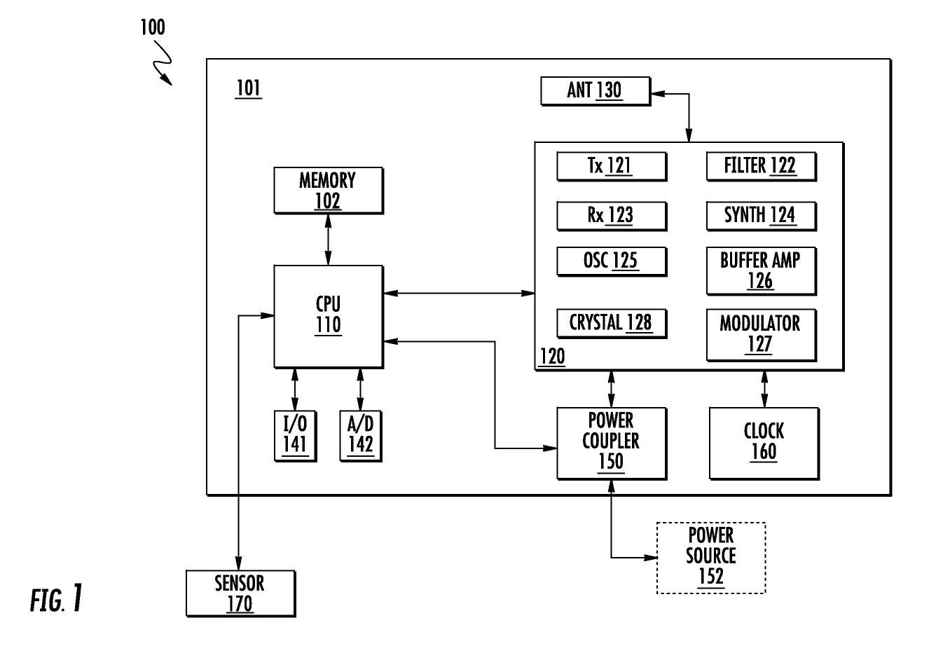

Turning to specific embodiments, FIG. 1 depicts a block diagram of a tracking device 100 that can be used in any or all of the use cases described above as well as other use cases that would be obvious to those of skill in the art. In a preferred embodiment, the tracking device 100 is designed to be used in a low power wide area network (“LPWAN”), which is an open standard frequency band located at about 900 MHz in the United States and 868 MHz in Europe. These bands are intended to be exemplary and not limiting. ISM bands vary from nation to nation. The embodiments disclosed herein are intended to operate on any ISM band in any country. Similarly, the physical structure of what we disclose could operate on bands outside of ISM bands. But the advantageous cost savings may be lost.

LPWAN is advantageous for embodiments of the invention because the tracking devices 100 can operate on low power while simultaneously having long range transmission capabilities. The tracking devices 100 disclosed herein are suitable for use in LPWAN because the tracking data transmissions, or event codes, are relatively small. In some embodiments, tracking devices 100 send less than 1000 bytes of data per day at 5000 bits per second or less.

The tracking device 100 is comprised of a circuit 101 coupled to a sensor 170. The circuit is on a substrate 101, wherein the substrate could be a thin film, a cardboard member, a plastic member, a paper member, or a composite wood member. In this and other embodiments, the circuit could be printed, etched or created via other methods well known in the art to create a conductive structure The circuit 101 can in embodiments contain any form of printed circuit board, which is comprised of copper plating, masking, and etching. In embodiments, the substrate 101 is designed to be flexible and thin so that it can be securely attached to items such as magazines, marketing mailings, assets, medical supplies, and similar items as described in the various use cases and as obvious to those of skill in the art.

The circuit can be comprised of memory 102, a processor 110, a transmitter 120, which can be a transceiver in some embodiments, a power coupler 150, and an antenna 130. In some embodiments, the memory 102, which could be a RAM, a flash memory, or any other memory known to those of skill in the art, is communicatively coupled to the processor 110. The processor 110 is communicatively coupled to the transmitter/transceiver 120 and a power coupler 150. The transmitter/transceiver 120, which is also communicatively coupled to the power coupler 150, can be further comprised of one or more of the following: a transmit block 121 a receive block 123, a filter 122, a synthesizer 124, an oscillator 125, a buffer/amplifier 126, a modulator 127, a crystal 128 and a power source 152.

The power source 152 can be a printable element such as carbon-zinc, zinc magnesium dioxide, batteries, or power sources known to those of skill in the art. Printing can be arranged so that the printing substrate 101 is compatible with the handling of a parcel or item containing the tracking device 100. Thus, printing on semi rigid substrates 101 such as circuit boards may be appropriate when rigid packaging and tracking device 100 construction is desirable or necessary. In other embodiments, the printing may be applied to fabrics that are flexible, such as Mylar.

The antenna 130 could be a loop or dipole formed from a length of conductive material or dielectric material. The shape, thickness, and composition of the antenna 130 will determine its radiation behavior, including the directivity and gain. It is advisable that the antenna 130 be non-directional so that transmission to a base station does not depend on the particular position or orientation of the parcel or its packaging, where the antenna 130 is embedded.

In some embodiments, it may be desirable to utilize physically small antenna 130 geometry in which antenna 130 features, including overall length or area, are smaller than the operating radio frequency wavelength. In these embodiments, the substrate 101 could be configured to provide a ground plane with respect to which the antenna 130 operates. The use of ground planes in antenna design is well known in the art. In the present invention, one point of novelty is the manner in which the overall tracking device 100 is integrated as a package. The ground plane can become an integral part of the substrate's 101 mechanical design as well as its electrical design. In some embodiments, the addition of a ground plane may be achieved by creating a “sandwich” structure in which the ground plane is inserted between two outer substrates 101. In this embodiment, the ground plane may be shared by antennas 130 printed separately on the two sides of the sandwich. This has the advantage of allowing smaller antenna 130 features while simultaneously providing antenna diversity, a benefit well understood in the art of communication system engineering.

In some embodiments, the antenna 130 will provide minimal or zero gain. In these embodiments, the RF communication function could be designed close the radio link with no antenna 130 gain. In fact, the RF link analysis must include and provide margin for significant obstruction of the radio signal in its propagation from the parcel to the wireless network receiving antenna. This procedure is well known in the art of radio communication system design.

As in the case of the power source 152, the choice of antenna 130 material and printing method is preferably determined in accordance with required sturdiness, rigidity, flexibility and other environmental factors. Both conventional circuit board materials and nonconventional materials or substrates and processes, including flexible dielectric and or conductive fabrics, etching of conductive fabrics or layers, deposition of conductive films, glues or paints, inks, and similar methods as will occur to one of ordinary skill will be readily available for realization of the present invention.

In some embodiments disclosed herein, the antenna is on the same substrate 101 as the transceiver 120, the processor 110, memory 102, or alternatively finite state machine in lieu of a processor 110 and memory 101, and power coupler 150.

In additional embodiments, the substrate 101 can also include input/output devices 141, an A/D and/or a D/A convertor 142, or a clock 160. The clock 160 could be used to measure a timeout event, or as an alarm or timer. In alternate embodiments, there could also be an RFID element, RF element, Wi-Fi element, Bluetooth element, cellular element, and the like coupled to or added onto the substrate 101.

The tracking device 100 also includes at least one sensor 170 coupled to the substrate 101. The sensor(s) 170 can be chosen to measure myriad events or conditions such as the opening of a package, breaking a seal, movement, temperature variation, acceleration, vibration, humidity, pressure, g-force, smoke detection, fire detection, gas detection, light, sound, orientation, stacking height, weight, and the like. For example, in the use case of mail marketing, a sensor 170 could be embedded in a parcel.

It is preferable in practicing the present invention that the above system elements are implemented in a low cost, low form factor and low power consumption manner. There are many techniques available for achieving these goals. One is to utilize significant custom circuitry rather than “off the shelf” components that are designed for other general purpose applications such as microprocessors or self-contained radio transmitters that may be available. In some embodiments, the tracking device 100 can be a custom-made, single purpose device. In embodiments, the custom circuitry could be placed on a silicon chip or die.

In the art, as is well known, there are technologies for creating and manufacturing such components. Furthermore, these technologies permit “mixed” analog, digital and radio frequency (RF) circuitry to be placed on a common substrate 101 or within a highly integrated miniaturized package. It is again important to realize that there are available, and may become available, other technologies different from silicon-based (or other semiconductor) chip design and manufacturing processes. These may include processes that print circuits on fabrics by painting or other deposition processes or processes that create circuitry by etching processes. The present invention is intended to subsume all of these particular manufacturing and design alternatives and no particular manufacturing or design alternative is intended to be required for or limit the teachings of the invention. It is anticipated that the merits of the invention will motivate many innovations in the field of ultra-miniaturized circuit design and that such process innovations will serve to amplify the utility of the present invention. Sensor considerations.

In one use case, the sensor 170 could be a conduction path consisting of fine wire or printed conducting material. The sensor 170 could be configured to open or close a circuit when the parcel is opened, that is, when the external packaging is opened to access the contents within. In alternate embodiments, additional sensors 170, which could detect the removal of package contents, could be included in the tracking device 100.

Upon detection of the “parcel opened” event, which alternatively could be called a state of integrity, a current flow or interruption may create a voltage across a sensing resistor, which in turn could awaken digital processing circuitry in the processor 110. When the processor 110 is activated by the “parcel opened” event, the binary code produced by the sensor 170 could be used to construct a pointer, which instructs the processor 110 about assembling a message, called an event code. This instruction can be processed either as a program jump in a software implementation or as a pointer (address) to a memory 102 location from which the event code is retrieved. The latter method has the benefit of using low cost memory 102 circuits rather than requiring a processor 110 to build the event code “on the fly” from primitive instructions.

The processor 110 can be thought of as a special purpose computer. In implementation, it may consist of a software controlled microcomputer that executes a stored program. In alternate embodiments, the processor 110 could be a small state machine or micro-coded bit slice processor. The latter will execute the same sequence of control operations as a software controlled microcomputer, but with the added advantage of being lower cost both in terms of manufacturing cost and power consumption cost.

The processor 110 is configured to receive input information from the sensors 170. Upon receipt of sensor 170 input, the processor 110 can generate an event code. The event code is a binary sequence that identifies an event. In many embodiments, the event code may be limited to having only a few bits of information therein. In alternate embodiments, event codes could be further expanded by means of well-known error correcting coding methods. One such coding method, which is exceptionally simple, is simply repeating the information bits a number of times. For example, if each bit is replicated 3 times, it is possible to detect a single bit error by simply majority logic. More powerful error correcting codes are also well known, such as BCH codes, and would be natural candidates for use in the present invention.

If the event codes are pre-stored in memory, the use of more complicated codes than the repetition code just described is straight forward. In either case, it will be clear to one of ordinary skill in the art that the use of event codes will enhance the performance of the system and that there are many coding schemes available in the literature from which to choose.

In an alternate embodiment, I/O devices 141 can be coupled to the processor 110. In these embodiments, the I/O devices 141 can be configured to detect additional events that may be coded as additional event codes.

In different embodiments, the tracking device 100 can have varying form factors including but not limited to differentiations in size, weight and power requirements. In some embodiments, the tracking device 100 may be provided in semi-knock-down form, in which case the components of the invention could be separated into major blocks, such as the RF electronics module 120, a battery/power source 152, an antenna 130, and at least one sensor 170. These blocks may be adjusted to accommodate various applications consistent with the present invention. For example, the power source 152 for some applications, like pallet or container tracking, may be made larger so that the usable active life of the transceiver 120 matches the pallet/container lifetime or in-service time interval. In other scenarios, such as direct mail, the power source 152 may be made very small because the tracking device 100 would only have to perform a small number of data transmissions.

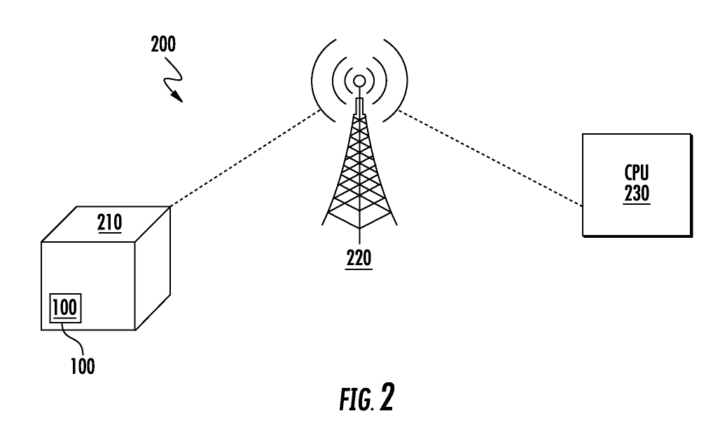

FIG. 2 shows a tracking network 200 according to the present invention. In this tracking network 200 there is a tracking device 100 affixed to an item 210, a low power wide area network 220, and a central processing unit 230, which serves as a logistics management client. The tracking network 200 is capable of receiving, demodulating and decoding a radio signal emitted from the tracking device 100, extracting the information carried by the signal, e.g., one or more event codes, and transferring the decoded payload via a digital network interface to a digital carrier network, such as the Internet or other digital network capable of routing digital information (such as data packets), which is further configured to forward the feedback message payload to a logistics management client 230. In some embodiments, the operators of the logistics management client 230 could use analytics sent from the tracking device 100 for myriad purposes such as determining location, temperature, humidity, user actions taken such as opening a package, and the like as previously described with reference to the tracking device 100. The logistics management client 230 can include some type of memory storage so that events associated with tracking device 100 can be stored and used in the future.

The logistics management client 230 can employ an application interface (API) that is specific to the wireless network in order to perform the information retrieval from the tracking network 200. This API could also be a conduit for data access stored in internal servers related to event codes and behaviors captured by the tracking network 200. In particular, if the tracking network 200 does not provide delivery of the feedback message to the logistics management client 230 via standard network routing techniques, e.g., an Internet using IP addresses, but rather stores the recipients' feedback datagram or datagram contents in a storage buffer, a method (utility or API) could be used to retrieve the contents from a storage location within the logistics management client 230.

In one exemplary use case, the tracking network 200 could be used to determine the outcome of a mailed marketing campaign. In this use case, once the parcel events, meaning the events that occur with respect to the parcel 210 at an individual mail recipient's home, have been deemed to have run their course, the next step could be transmitting an event code from the tracking device 100 to the network 220. The event codes could reflect parcel events such as whether or not the parcel 210 was opened. If the parcel was never opened, in some embodiments, there may be no signal sent over the tracking network 200. In other embodiments, a system timeout could be employed whereby an event code is transmitted after expiration of the timeout period indicating that the mail recipient never opened the parcel 210, which presumably means it was discarded.

In this embodiment, the event code could be formatted to include a field of binary information containing an event code payload. The event code payload could contain a unique address code for the parcel 210, or an encoded equivalent thereof, a message element identifying what happened to the parcel 210, and an address of the central processing unit 230, or logistics management client. In these embodiments, it may be desirable to correlate the tracking device 100 with a parcel 210 recipient.

The radio signal transmitted in the tracking network 200 can include a short header and or preamble field that may be used by the wireless network for synchronization and identification purposes. An additional non-information bearing stabilization preamble may also be provided so that the radio frequency circuits have time to stabilize before the information bearing portion of the radio signal, i.e., header, preamble, and payload, is passed through the circuit.

Once the composite binary signal is prepared, it is necessary to apply the modulation process to it to create a radio frequency signal. The modulation process is specific to the radio network employed. There are numerous modulation processes to choose from. The one that is described here is typical. Any other modulation process can be supported and would be effective in realizing the present invention so long as it is compatible with the wireless transport network the system is operating on. It is well known in the art how to create modulated digital communication signals and one of ordinary skill in the art can readily adapt the teachings herein to accommodate any of them.

Some examples, without limitation, of suitable wireless networks are SIGFOX, long range radio “LoRA”, Weightless, Greenwave, LTE-MTC, Haystack, Ingenu Random Phase Multiple Access, or Narrow-Band Internet of Things (“N-B IoT”).

In some network embodiments, it may be advantageous to use multiple transmissions to ensure the event codes are correctly processed. In this embodiment, the processor 110 within the tracking device 100 could be programmed to stagger the repetitions of the radio signal transmission so as to minimize burst traffic overloads on the wireless network 220. In alternate embodiments, burst traffic should not be an issue because the traffic generated by the system is of very low volume, which means the wireless network 220 can accommodate a burst of continuously repeating transmissions that lasts a fraction of a second.

The Pairing Process is the process of associating an individual tracking device 100 with a recipient or asset owner. In some embodiments, the tracking device 100 includes a means for programming information that is specific to the intended recipient, which may be a postal address or other unique recipient identifier. Recipient identification data is made available to the logistics management client 230, which, in turn, can translate event codes into information legible and useful to end users. This programming of the tracking device 100 for this use case, can be implemented at the manufacturing stage. For example, the tracking device 100 could be loaded during manufacturing with a generic but unique identifying code that will be transmitted as part of a modulated signal. During manufacture, and after the point in time when recipient-specific data for a particular tracking device 100 becomes known, the tracking device's 100 unique identifying code may be stored in a database together with the associated recipient-specific data, for later use by the logistics management client 230. In this scenario, the tracking device's 100 unique identifying code may be accessed via optical scanning or electrical interface, or other means convenient and suitable within a mass production environment.

Alternatively, the programming means may be arranged in a manner that allows the tracking device 100 to receive digital information wirelessly by being placed in the field of a programming instrument. Still another method of programming, which utilizes a reverse process, is to provide the tracking device 100 with a passive identification emission means, similar to RFID, in which the tracking device 100 emits a unique identification code. The unique code could be associated with a physical address of the intended recipient. In this method of programming, a return address, i.e., the address of the logistics management client 230, could be built into the tracking device 100.

A further variation of the above means is an externally readable serial number, which may be printed on the substrate 101 of the tracking device 100. This serial number could be input to a separate automatic or manual process of pairing.

In terms of programming the tracking device 100, in some embodiments, the processor 110 can contain preprogrammed, executable software. In alternate embodiments, the tracking device 100 could configuration mapping information that produces the desired operation instantiating one or more functions that are available within the tracking device 100. In this embodiment, the tracking device 100 could be manufactured with preset capabilities that are available via programming according to the application. By way of example, for the direct mail marketing use case, programming may include correlating a physical address of a mail recipient with a specific tracking device 100. Programming may also include, providing time information to memory 102 or clock 160 and setting an address for the logistics management client 230.

In one embodiment, the programming of the tracking device 100 can operate “in reverse”. In this embodiment, the tracking device 100 could be equipped with a means of transferring its built in electronic identifier to an external device (such as an RFID reader). The external device could be configured to read the tracking device's 100 electronic identifier and associate it with a particular physical mailing address, or other use case metric.

In additional embodiments, the tracking device 100 can be programmed to perform various sensing, monitoring and reporting functions at prescribed intervals and frequencies. Such programming would, for example, set the frequency of temperature reporting if a temperature sensitive item is being tracked. As another example, the temperature threshold for which such monitoring should generate an alarm and report would be programmable.

In one embodiment, the programming is performed using a very simple serial interface in which a bit sequence is applied to the processor 110 through an input-output (I/O) terminal. Tracking devices 100 can be manufactured with the capability of supporting any of a plurality of applications. The multiplicity of capabilities preferably is described by the types of sensors available in the application deployment, while the logic that controls the reporting is described by internal digital logic that is configurable through either manufacturing parameter settings (hard coding) or through the aforementioned serial I/O port. In certain embodiments, the multiplicity of sensor 170 types and configurations, especially the external sensor circuitry, is managed separately from the multiplicity of reporting and monitoring settings. The reporting and monitoring settings are preferably controlled through digital logic. When the digital processor 110 is programmed, the bit pattern input on the serial port induces, or instantiates, a particular configuration of the control logic inside of the processor 110. This configuration can be stored in memory 102, and the particular configuration selected via a memory address or offset or block of addresses.

In another embodiment, the programming of the digital control can be based on finite state recognizer technology. This type of programming is useful when it is desired to make the tracking device 100 especially small. In particular, the digital processor 110 may be designed without a software processor, thereby reducing cost and complexity of the digital subsystem. Finite state recognizer technology is known in the art of computer engineering, especially in the art of compiler design. In short, this technique operates by accepting a string or stream of tokens (in preferred embodiments of the present invention the tokens are simple binary symbols represented by voltages or currents injected through an I/O pin or terminal or port) and sequentially processing said string or stream in order to “parse” the “string sentence” into meaningful directives. Such a stream processing means can be realized by defining certain bit patterns that are recognized and which cause a state machine to transition into desired control states. In one embodiment, the state can be a pointer to a segment of microcode.

In another embodiment, the state can be a register word that controls selected primitive functions that are predefined at tracking device 100 manufacturing time but which are only instantiated as a result the programming. It will be clear to one of ordinary skill in the art of computer programming, especially microcontroller and similar device programming (firmware programming), that the above method can be designed in a manner that removes the need for a resident software control program and associated general purpose processing elements (CPU 110, memory 102, etc.). The benefit of this type of design is minimization of chip complexity (gate count, logic blocks, number of transistors, etc.) and power consumption.

In another embodiment, which is at the other end of the complexity spectrum but which is somewhat more standard, programming of the tracking device 100 can be achieved by loading a program file into memory 102 or the processor 110. This could be done in some embodiments with an I/O device 141.

There are several ways to produce the circuitry 100 with components as functional modules. In one embodiment, we use a classical printed circuit board (“PCB”) made of an epoxy with copper layer, having a protection layer on the copper, whereby a portion of the protection layer is removed. In this embodiment, we include etching in the free copper area. We also strip off the rest of the protection layer from the remaining copper traces. We further include stencil printing of solder paste to the copper traces. The components are “pick & place” and are secured to the PCB via a heating process in a reflow oven for soldering.

In an alternate embodiment, the circuitry 100 could be produced by using a rigid epoxy-copper PCB a thin and flexible Polyimide film with a copper layer in place of the PCB.

In an alternate embodiment, the circuit 100 could be printed via a printing process for conductive traces (e.g. silver traces) to a film (e.g. Polyethylene terephthalate, Polyethylene naphthalate, and the like) using stencil printing of solder paste. In this embodiment, it would be advisable to use low temperature solder paste because these polymer films cannot stand the high solder temperatures of normal soldering. This embodiment could also place components via “pick & place,” followed by heating up for soldering.

In an additional embodiment, the circuit 100 could be printed via a printing process for conductive traces (e.g. silver traces) to a film (e.g. Polyethylene terephthalate, Polyethylene naphthalate, and the like) and stencil printing or normal printing of a glue or binder, which conductively glues the components to the silver traces. In this embodiment, the circuit 100 could be cured at room temperature or heated up for faster curing.

The printing methods for printing the circuits 100 can vary in alternate embodiments. In one embodiment, one could use a screen printing method or process, which has the advantage of providing relatively thick conductive layers with sufficient resolution. In an alternate embodiment, one could use a gravure printing process, which has the advantage of having a lower thickness than screen printing, while still having good resolution.

In an alternate embodiment, the circuit 100 could be printed with a flexographic printing method, which provides thickness similar to gravure and sufficient resolution.

In alternate embodiments, in order to increase thickness, any of the above printing methods could be combined with printing seed layers having electroplating or electro-less platting thereon.

In these methods, diverse curing methods, such as convection heating, infra-red, ultraviolet, ultrasonic, and photonic, could be used. These curing methods are also useful if sintered nanoparticles are used.

Many different materials can be used to print conductive traces, including without limitation: carbon (including graphene), silver, copper, silver plated copper, organic conductive polymers, tin, and inorganic materials like indium tin oxide.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context.

The invention includes embodiments in which exactly one member of the group is present in, employed in, or otherwise relevant to a given product or process. The invention also includes embodiments in which more than one or the entire group of members is present in, employed in or otherwise relevant to a given product or process. Furthermore, it is to be understood that the invention encompasses all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise.

Where elements are presented as lists, (e.g., in Markush group or similar format) it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification. The entire contents of all of the references (including literature references, issued patents and published patent applications and websites) cited throughout this application are hereby expressly incorporated by reference.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification, embodiments have been described in a way which enables a clear and concise specification to be written, but it is intended and will be appreciated, that embodiments may be variously combined or separated without departing from the invention. It is intended that the present invention be limited only to the extent required by the appended claims and the applicable rules of law.

What is claimed is:

1. A tracking device for use in a low power wide area network (LPWAN) comprising:
a. A circuit on a substrate, the circuit further comprising a processor, a memory, a transmitter, and a power coupler configured to receive power from an external source;
b. A printed antenna on the substrate communicatively coupled to the circuit; and
c. A sensor communicatively coupled to the circuit.

2. The tracking device of claim 1 further comprising a receiver.

3. The tracking device of claim 1 wherein the substrate comprises a thin film, a cardboard member, a plastic member, a paper member, a composite wood member, or a circuit board.

4. The tracking device of claim 1 wherein the circuit and the antenna are coplanar.

5. The tracking device of claim 1 wherein the processor is a small state machine or a micro-coded bit slice processor.

6. The tracking device of claim 1 further comprising a clock.

7. The tracking device of claim 1 wherein the sensor is configured to monitor at least one data metric the data metric comprising one of more of: a temperature, a measurement of relative humidity, a traveling velocity, an acceleration, a measure of light, a shock, a pressure, a vibration, a location, a gas, a fire, an orientation in space, a g-force, a sound, a stacking height, a weight, or a state of integrity.

8. The tracking device of claim 1 wherein the processor is configured to create an event code based on input received from the sensor.

9. The tracking device of claim 1 wherein the transmitter is configured to transmit an event code.

10. The tracking device of claim 1 further comprising a power source wherein the power source comprises one or more of a battery, a capacitor, a super capacitor, a solar power collector, or a wireless power device.

11. The tracking device of claim 1 wherein the power source is a printed battery or a printed capacitor.

12. The tracking device of claim 1 wherein the LPWAN network is a SIGFOX network, a long range radio “LoRa” network, a Weightless network, a Greenwaves network, an LTE-MTC network, a Haystack network, an Ingenu Random Phase Multiple Access, or a Narrow-Band Internet of Things (“N-B IoT”) network.

13. A tracking device for use in a low power wide area network (LPWAN) comprising:
a. A circuit on a substrate, the circuit further comprising a finite state machine, a transmitter, and a power coupler configured to receive power from an external source;
b. A printed antenna on the substrate communicatively coupled to the circuit; and
c. A sensor communicatively coupled to the circuit.

14. A tracking system for tracking a data metric of an item comprising:
a. the tracking device of claim 1;
b. a low power wide area network configured to receive and transmit the data metric; and
c. a computer processor configured to receive and analyze the data metric.

15. A method of tracking an item using the tracking device of claim 1 comprising the steps of:
a. Receiving from the tracking device a data metric measured by the sensor; and
b. Analyzing the data metric in order to determine a tracking state.
